(19) United States
(12) Patent Application Publication
(10) Pub. No.: US 2010/0265254 A1
(43) Pub. Date: Oct. 21, 2010

(54) Graphics filled shape drawing

(75) Inventors: Eivind Liland, Trondheim (NO); Erik Faye-Lund, Oslo (NO); Espen Amodt, Trondheim (NO)

Correspondence Address: NIXON & VANDERHYE P.C., 901 N. Glebe Road, 11th Floor, Arlington, VA, 22203-1808, US

(73) Assignee: ARM LIMITED, Cambridge (GB)

(21) Appl. No.: 12/659,284

(22) Filed: Mar. 3, 2010

(30) Foreign Application Priority Data
Apr. 17, 2009 (GB) 0906690.3

(51) Int. Cl. G06T 11/20

(52) U.S. Cl. 345/441

(57) ABSTRACT

A filled shape is defined by edge data forming one or more boundaries thereof. Local shape data is generated from the edge data for each graphics region overlapped by the filled shape. The local shape data separately represents for each graphic region at least any edge of the filled shape within the graphics region and an overlap value indicative of a difference between a number of times the boundaries of the filled shape surround the region in a clockwise direction and the number of times the boundaries surround the region in a counter-clockwise direction. For each graphics region having local shape data, the local shape data is used to generate pixel values for pixels within that graphics region that are within the filled shape to be drawn.

### BACKGROUND OF THE INVENTION

1. Field of the Invention

This invention relates to the field of graphics systems. More particularly, this invention relates to the drawing of filled shapes within graphics systems.

2. Description of the Prior Art

The use of vector graphics is increasingly popular within graphics systems in view of its speed and efficiency. Flash, OpenVG, SVG and GDI+ are examples of popular vector graphics applications and application programming interfaces used for drawing vector graphics. One of the significant performance-critical operations in these applications is the generation of pixel values for arbitrary filled shapes (such as polygons, shapes with curved edges or shapes with a mixture of curved and straight edges).

One known technique for filled shape rasterization is to use a general purpose central processing unit. This approach favoured algorithms ill-suited to use within modern highly parallel graphics processing units. One way to address this problem is to use a triangulation algorithm such as is illustrated in FIG. 1 of the accompanying drawings. Triangulation breaks the polygon into non-overlapping triangles and rasterizes these non-overlapping triangles on a graphics processing unit. Self-intersecting polygons are processed according to a fill rule in order to generate an equivalent set of triangles.

Held, M., FIST: Fast Industrial-Strength Triangulation of Polygons. Algorithms 30(4): 563-596, 2001, http://comsbg.ac.at/˜held/projects/triang/triang.html describes an example of this triangulation method. A problem with this method is that pre-calculation is required of the non-overlapping triangles before the rasterization can be handed over to a parallel graphics processing unit. This processing bottleneck makes it difficult to provide high speed operation and support tasks such as animation.

The central processing unit overhead of concave polygon triangulation, such as is used in the triangulation algorithm, may be avoided at the cost of some potentially redundant polygon filling in the graphics processing unit by using the known stencil algorithm, such as described in SHREINER, D., WOO, M., NEIDER, J., AND DAVIS, T. Drawing Filled, Concave Polygons Using the Stencil Buffer, fourth ed. Addison-Wesley, 2004, ch. 14, pp. 600-601.

FIG. 2 of the accompanying drawings illustrates the stencil algorithm. Triangles are formed by connecting each line segment forming an edge of the polygon to an arbitrary fixed pivot point thereby creating a triangle fan. This is a simple process and can be performed quickly. The remainder of the algorithm may be performed on a graphics processing unit in parallel using stencil buffer operations.

The stencil buffer is a buffer in the graphics processing unit which contains one integer for each pixel of the screen. The graphics processing unit can be configured so that when rendering a triangle, the stencil buffer of values covered by the triangle are either incremented or decremented. When rendering using the stencil algorithm, increment or decrement based upon the orientation of the triangle may be performed in order to determine overlap, e.g. a triangle that has its three vertices in a clockwise order increments the stencil value whereas a triangle with its vertices in a counter-clockwise order decrements the stencil value.

The result of this incrementing and decrementing of the stencil values is that the pixels that are outside of the polygon have a stencil value of zero when all the triangles have been processed while the pixels that are inside one piece of the polygon have a stencil value of one. Pixels that are covered multiple times by the polygon have a higher stencil value. The final result is that the stencil buffer contains the overlap at each pixel.

Following the generation of the stencil buffer values, polygon can be drawn into the frame buffer. OpenVG has two fill rules that can be implemented i.e. filling all pixels that have either odd or non-zero stencil values in the stencil buffers depending upon which fill rule is being used. When a non-zero fill rule is being used, the stencil buffer technique may be limited to a certain number of overlaps in order that the stencil buffer does not overflow. This is not an issue with the odd/even fill rule since a record only needs to be kept of whether the value is odd or even.

As will be seen from FIG. 2, the stencil algorithm creates a large number of long, thin triangles termed “slivers”. These slivers are undesirable for a number of reasons. The long edges of such slivers result in a large number of dummy pixel-shaders being launched along the edges because most graphics processing units render pixels in 2×2 groups. With immediate mode renderers, there is no spatial locality in the frame-buffer accesses when rendering such slivers and this reduces cache performance and leads to high bandwidth requirements and low performance due to a large volume of frame buffer traffic (including decompression and compression).

For tile-based renderers, the large number of diagonal slivers which tend to be generated can result in bounding boxes that are much larger than the triangle itself. This effect is illustrated in FIG. 3 of the accompanying drawings. This bounding box simplification which is often used in tile based renderers, leads to a substantial increase in the bandwidth for the tile list commands and vertices when using bounding boxes to render with this stencil algorithm. Another problem with the stencil algorithm in that it can produce a lot of overdraw. This is wasteful.

### SUMMARY OF THE INVENTION

Viewed from one aspect the present invention provides a method of generating a plurality of graphics regions within a frame of graphics data, each graphics region corresponding to an array of pixels for display, said method comprising the steps of:
receiving edge data defining a plurality of edges forming one or more boundaries of a filled shape to be drawn;
generating local shape data from said edge data for at least each graphics region overlapped by said filled shape, said local shape data separately representing for each graphics region at least:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction; and
for each graphics region having local shape data, generating from at least said local shape data pixel values for pixels of said graphics regions that are within said filled shape to be drawn.

The present technique creates the local shape data representing the overlap of the filled shape with the tile under consideration. This local shape data does not produce the long, thin slivers associated with the stencil algorithm which result in the above discussed problems. Furthermore, overdraw due to concave portions of the filled shape is limited to within the graphics region.

While it will be appreciated that the filled shape can have a variety of different forms and different forms of edges, the present technique is well suited to the drawing of filled polygons.

The edges can include one or more straight edges, one or more curved edges and mixtures of curved and straight edges.

The present technique may be used both for immediate mode renderers and tile-based renders. When used with tile based renders, the plurality of graphics regions may comprise an array of graphics tiles of a common size. The tile-by-tile nature of the processing in generating the local shape data reduces memory traffic which is advantageous in increasing speed and reducing energy consumption.

It will be appreciated that when the drawing of a filled shape is performed in such a manner, graphics regions may be encountered which are fully occluded by the filled shape. Such regions may be detected by detecting graphics regions having no edges of the filled shape within the graphics region and an overlap value indicative of the graphics region being within the filled shape.

When such fully occluded graphics regions are detected, all graphics objects having a greater depth within the graphics region concerned may be deleted from an object list of objects to be drawn for the graphics region. This reduces the processing overhead.

In a similar way, graphics regions which are not overlapped and which have no edges of the filled shape within them may be skipped.

The overlap value that forms part of the local shape data may have a variety of different forms depending upon the graphics protocol being used. In some embodiments an overlap value that is non-zero indicates that the graphics region is within the filled shape. In other embodiments an overlap value that is odd is indicative of a graphics region being within the filled shape.

The generation of the local shape data for each graphics region may be performed in different ways. In some embodiments the local shape data may be generated by a local application of the stencil algorithm previously discussed. In other embodiments the local shape data may be formed using a triangulation algorithm as previously discussed.

Each array of pixel values of a graphics region may be separately accessed from a memory. In this context, the present technique may be advantageous in permitting pixel values for pixels of the graphics region that are within the filled shape to be drawn and written during one access operation to the memory. This advantageously reduces memory traffic.

The drawing of the filled shape may be performed by a graphics processor coupled to the memory with the pixel values for a given region being drawn during the one access to that graphics region discussed above.

The present technique provides an advantage when used in systems that generate the local shape data by performing processing upon a bounding block comprising a plurality of graphics regions and surrounding the filled shape. Such bounding block approaches normally increase the amount of processing compared with only processing graphics regions that are intersected by the filled shape. The present technique helps reduce this additional processing burden.

The local shape data may be directly or indirectly stored for the graphics region to specify the edge and overlap values previously discussed.

Viewed from another aspect the present invention provides an apparatus for generating a plurality of graphics regions within a frame of graphics data, each graphics region corresponding to an array of pixels for display, said apparatus comprising:
an edge data receiver coupled to a memory to receive edge data defining a plurality of edges forming one or more boundaries of a filled shape to be drawn;
a local shape generator responsive to said edge data to generate local shape data for at least each graphics region overlapped by said filled shape, said local shape data separately representing for each graphics region at least:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction; and
a render responsive to at least said local shape data to generate for each graphics region having local shape data pixel values for pixels of said graphics regions that are within said filled shape to be drawn.

Viewed from a further aspect the present invention provides an apparatus for generating a plurality of graphics regions within a frame of graphics data, each graphics region corresponding to an array of pixels for display, said apparatus comprising:
edge data receiving means coupled to a memory for receiving edge data defining a plurality of edges forming one or more boundaries of a filled shape to be drawn;
local shape generating means responsive to said edge data for generating local shape data for at least each graphics region overlapped by said filled shape, said local shape data separately representing for each graphics region at least:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction; and
rendering means responsive to at least said local shape data for generating for each graphics region having local shape data pixel values for pixels of said graphics regions that are within said filled shape to be drawn.

Viewed from a further aspect the present invention provides a computer program product comprising a computer readable storage medium storing a computer program for controlling a data processing apparatus to perform a method of generating a plurality of graphics regions within a frame of graphics data, each graphics region corresponding to an array of pixels for display, said method comprising the steps of receiving edge data defining a plurality of edges forming one or more boundaries of a filled shape to be drawn;
generating local shape data from said edge data for at least each graphics region overlapped by said filled shape, said local shape data separately representing for each graphics region at least:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction; and
for each graphics region having local shape data, generating from at least said local shape data pixel values for pixels of said graphics regions that are within said filled shape to be drawn.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates the use of a triangulation algorithm for drawing a filled polygon;

FIG. 2 schematically illustrates the use of a stencil algorithm for drawing a filled polygon;

FIG. 3 illustrates the drawing of a sliver generated with a stencil algorithm when using both exact tiling and bounding box tiling;

FIG. 4 illustrates a filled polygon with straight edges;

FIG. 5 illustrates a filled polygon with curved edges;

FIG. 6 illustrates a filled polygon that is concave broken down into a plurality of local shapes of which only one is concave;

FIG. 7 schematically illustrates a filled polygon in which the boundary is traced to determine the overlap value at different points;

FIG. 8 illustrates a polygon edge primitive for three different edges;

FIG. 9 schematically illustrates the result of the overlap count for the polygon edge primitives of FIG. 8;

FIG. 10 illustrates an algorithm for adding paint commands to the object list of a tile-based graphics processing unit;

FIG. 11 schematically illustrates bounding box binning used in conjunction with the present techniques;

FIG. 12 is a flow diagram schematically illustrating processing during local shape data generation;

FIG. 13 is a flow diagram schematically illustrating processing during rendering of tiles; and

FIG. 14 is a diagram schematically illustrating a system-on-chip integrated circuit including a graphics processing unit for performing the techniques discussed above.

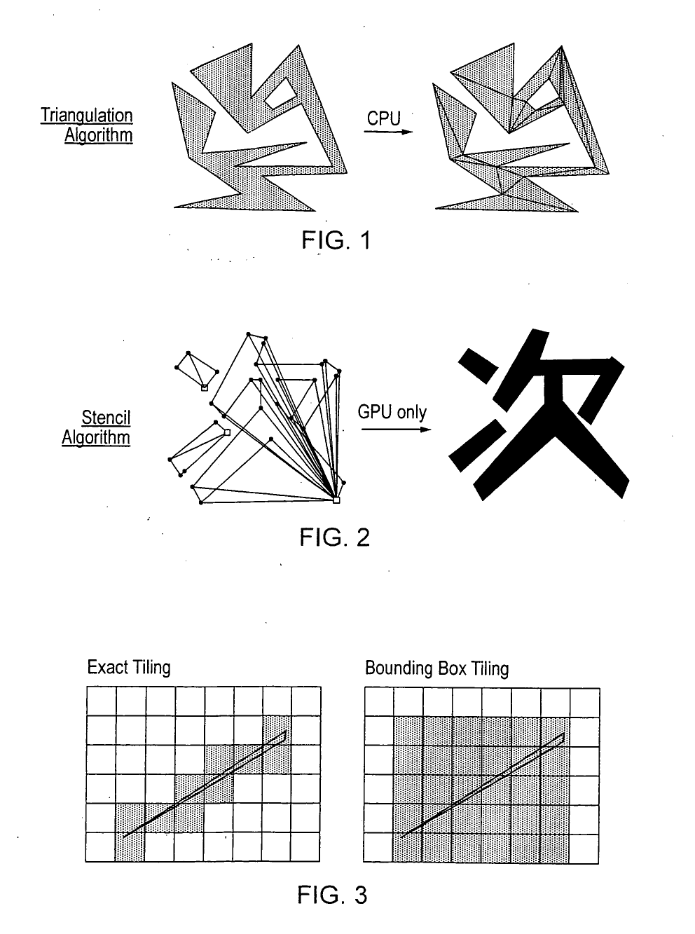

### DESCRIPTION OF THE PREFERRED EMBODIMENTS

When triangulating polygons the problem is often considered globally—any edge may affect any pixel. However, this problem may be broken down into multiple local problems, e.g one problem per tile. If no edges cross a given tile, no pixels change state and so the visibility of the entire tile can be evaluated once for the entire tile.

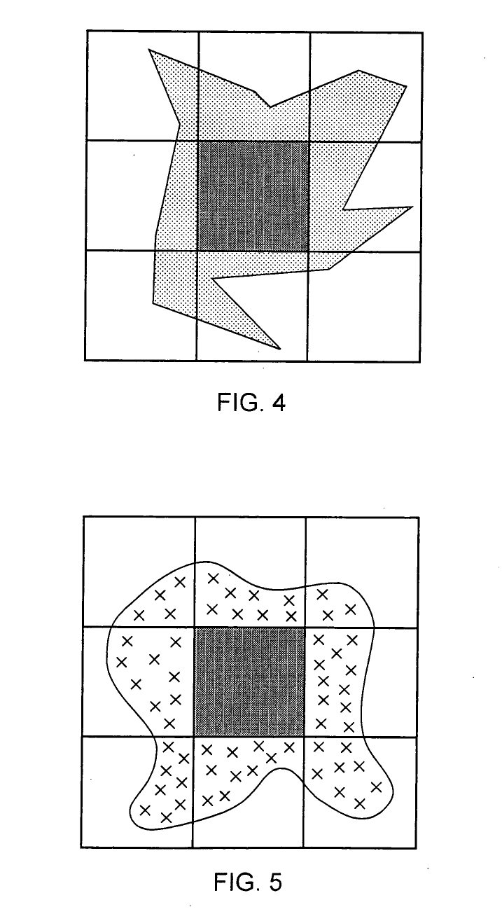

FIG. 4 illustrates a filled shape with straight edges (polygon). FIG. 5 illustrates a filled shape with curved edges. It can be noted that since occlusion is known for the entire middle-tile, use of the stencil-technique can be avoided for this tile, thereby saving both fill-rate (complex polygons cause overdraw in the stencil-buffer), and reducing the triangle-count for that tile. All objects at a greater depth within an object list for the tile can be deleted as they will be overdrawn by the filled tile.

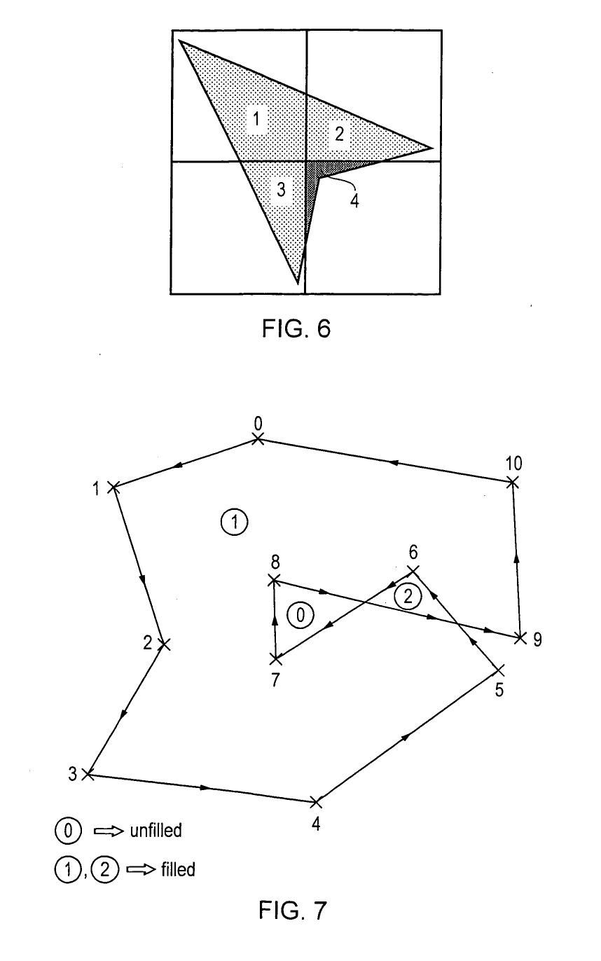

The local processing can be used to reduce overdraw; for a given tile only those edges that cross the tile need to be rendered. This has the added benefit that it can in some cases cause concave polygons to become a series of convex intersections of the polygons and tiles (e.g. FIG. 6 shows this effect). This approach results in intersection being done automatically by the rasterizing hardware. Custom tile-lists binning is performed with this technique.

Notice how parts 1, 2 and 3 of the polygon of FIG. 6 are convex, even though the polygon itself is concave. Part 4 is concave, but the opposite area of it is convex, and can thus be rendered as a convex polygon as well, but with inverted fill-area.

### DETAILED DESCRIPTION

The algorithm may be performed in several stages:

1. Silhouette and polygon overlap

### 2. Paint

3. Pixel processing

Stage 1: Silhouette and Polygon Overlap

The goal of this stage is to create the following data structure (local shape data). For each tile:
Tile-list: A list of all the edges intersecting the tile
Polygon overlap: The overlap at the upper-left corner of the tile
“twopass” bit: True if at least one edge intersects the tile, otherwise false.

By overlap, we mean the number of clockwise overlaps minus the number of counter-clockwise overlaps between the polygon and a given point. This is illustrated in FIG. 7 which shows the number of times each area is surrounded in a counter-clockwise minus a clockwise direction to form an overlap value. In this protocol, non-zero overlap values are filled. It is also possible to use a protocol whereby odd overlap values are filled and even unfilled.

Creating the tile list requires going through the list of edges in the polygon and adding an entry to each tile they intersect.

The edge is tiled into the tile list for each tile which intersects the edge. Edges are added to tile lists either as a polygon edge primitive composed (see discussion of Polygon Edge below). The render state is set such that clockwise primitives increment and counter-clockwise primitives decrement the stencil buffer.

If each edge is tiled into all tiles on the screen, every Polygon Edge primitive would extend to the far right edge of the screen. This would use a lot of fillrate, but the “polygon overlap” calculations could be skipped with fill doing a stencil test against zero. Instead, the extent of the primitive is limited by tiling it only into the tiles it intersects. The “polygon overlap” calculations are then used (corresponding to a low-res rasterization of the polygon) to give a per-tile mask with which to test during filling, to simulate that the primitive was extended to the edge of the screen.

The triangles for the Polygon Edge primitive are constructed from the five coordinates V0, V1, C0, C1 and R. V0 and V1 are the start and end vertices of the polygon edge. C0 and C1 are the lower-right corners of the two tiles where V0 and V1 are located. R is infinitely to the far right: (inf, 0). The triangles are constructed as:
Triangle 1: C0, C1, R
Triangle 2: V0, V1, C0
Triangle 3: C0, V1, C1

If the vertices are in the same tile, or the same row or column of tiles, then some of the triangles can be omitted while still giving the same result.

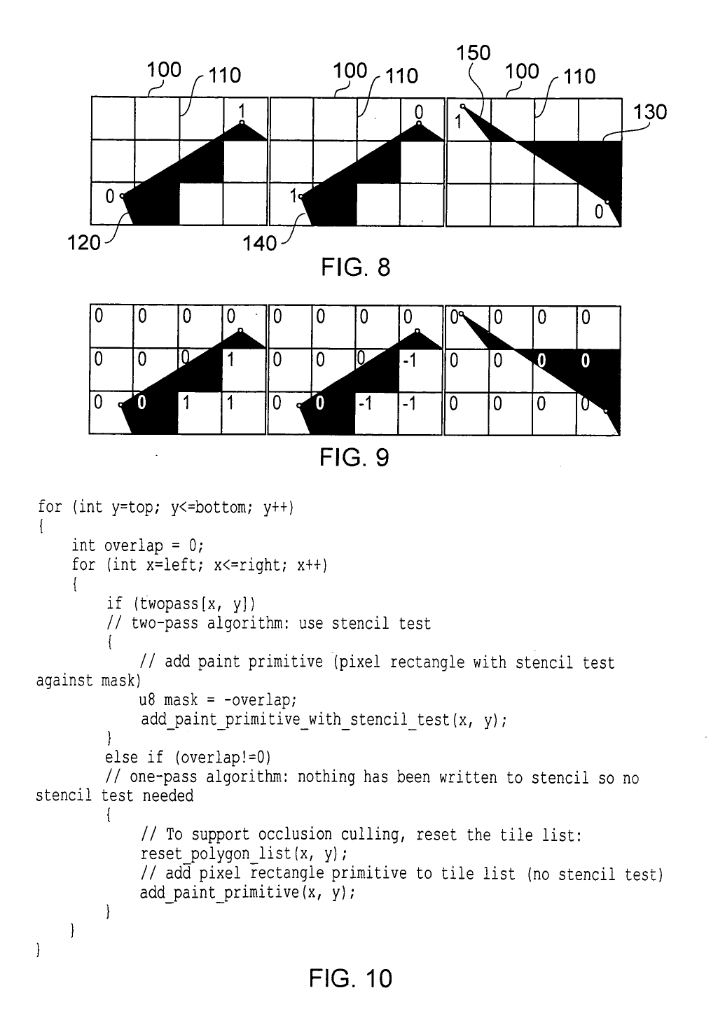

FIG. 8 shows a polygon edge primitive for three different edges. The border 100 represents the tile-aligned bounding box of the edge. The grid 110 represents tiles.

Areas 120 and 130 are clockwise primitive and areas 140 and 150 are counter-clockwise primitives. In the third view, triangles 2 and 3 partially cancel out triangle 1: the stencil buffer will now contain the overlap of each pixel relative to the overlap at the top-left corner of the tile.

The polygon overlap represents the polygon overlap value at the top-left corner of the tile. It corresponds a low-resolution rasterization of the polygon, with one value per tile.

It can be calculated in two ways (for example):
1. By rasterizing the polygon in low-resolution using the normal stencil algorithm. Pixel sampling locations in the low-resolution version must coincide with the upper-left corner of the tiles in the high-resolution version.
2. Using the overlap accumulation algorithm while doing tile list building.

The overlap accumulation algorithm will be familiar to those in this technical field and has been used on computers such as the Commodore 64. It consists of two stages:

### 1. Edge Rasterization

### 2. Horizontal Accumulation

Edge rasterization consists of updating overlap counts at the edges, and is performed like this:

i) For each edge:
(1) For each row of tiles intersected by the edge, except the uppermost:
(a) Find the rightmost tile intersected by the edge
(b) Pick the tile just to the right of that tile
(c) Let the coordinates of the edge be (x0, y0)−(x1, y1)
(d) If (y0<y1)//winding==clockwise
(i) tile.overlap++;
(e) else//winding==counter-clockwise
(i) tile.overlap−−;
Horizontal accumulation scans from left to right and accumulates the values and writes them back as the final polygon overlap value:
i) For each row of tiles:
ii) acc=0;
iii) For each tile, from left to right:
iv) acc+=tile.overlap;
v) tile.overlap=acc;

Independent of which technique is used to generate the overlap counts, the result should appear like that shown in the example of FIG. 9.

A “twopass” bit may be set during the tile list building. It will be set to 0 initially, then set to 1 if any edge passes through the tile.

Stage 2: Paint

The goal of this stage is to add the stencil-test and paint-commands to the tile lists. All the tiles of the bounding box of the polygon are iterated through. For each tile, if the twopass bit is not set, then it is either skipped it or filled completely. If the twopass bit is set, then a primitive is added that fills each pixel depending on the value of the stencil buffer.

The algorithm for adding paint commands is illustrated in FIG. 10.

Note that the algorithm supports occlusion culling in that it can reset tile lists when it finds that it is completely covered by paint. To reset the tile list, the pointer to the start of the tile list is modified to the current location so that any commands previous to the current one are skipped.

Stage 3: Pixel Processing

This stage involves reading in the tile lists, processing the geometry and the pixels and drawing it into the frame buffer.

Alternative Designs

Running Algorithm on an Immediate Mode Renderer

Instead of adding primitives to tile lists, set a scissor box around the area and draw it immediately.

Bounding Box Binning

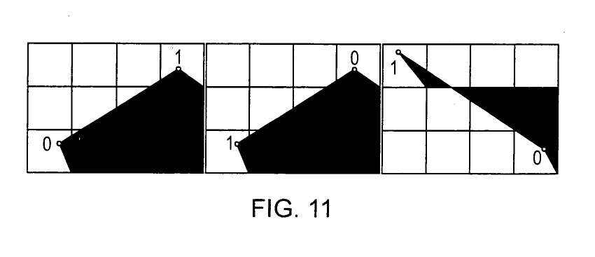

Instead of tiling edges into tile lists in an exact fashion, a conservative method known as bounding box tiling can be used. The primitive is then added to the tile list of all tiles intersecting the edge's bounding box instead of the edge itself. This also has implications for how the overlap counts are generated. FIG. 11 shows an edge tiled with bounding box tiling.

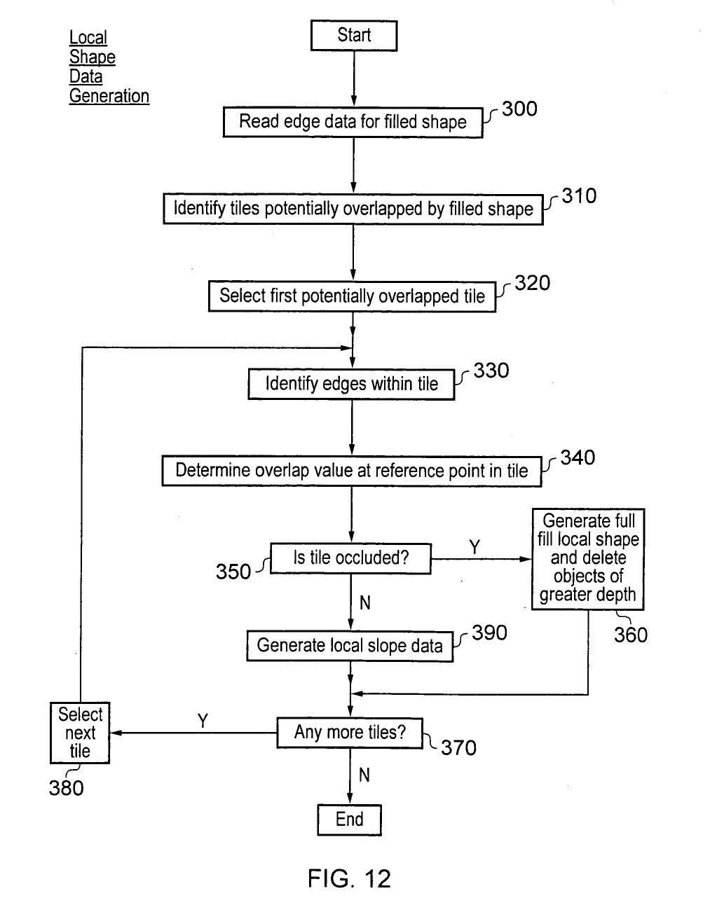

FIG. 12 is a flow diagram schematically illustrating the processing in accordance with one example of the present technique. At step 300 edge data defining a filled shape is read from a memory. At step 310 tiles potentially overlapped by the filled shape are identified. Step 320 then selects the first potentially overlapped tile from those identified at step 310.

Step 330 identifies the edges within the currently selected tile for the filled shape. Step 340 determines the overlap value at a reference point in the tile for the filled shape. Step 350 then determines whether or not the tile is occluded as indicated by containing no edges and with an overlap value indicating it is within the filled area of the filled shape. If the tile is occluded, then processing proceeds to step 360 where local shape data corresponding to a full fill of the tile is generated and objects of a depth greater than the local shape data are deleted from an object list for that tile. Processing then proceeds to step 370 where a determination is made as to whether or not there are any more tiles identified as potentially overlapped at step 320 which have not yet been processed. If there are such tiles, then the next tile is selected at step 380 and processing is returned to step 330. If there are no remaining potentially overlapped tiles, then processing terminates.

If the determination at step 350 is that the tile is not occluded, then step 390 serves to generate the local shape data including any polygon edge primitives as previously discussed, or other forms of local shape data. The local shape data may for example be formed using a triangulation type of algorithm in which the overlapped portion of the tile is broken down into a set of tessellating triangles which can then be drawn. A more conventional stencil algorithm within the tile concerned could also be performed using a reference point at for example, one corner of the tile being drawn. The local shape data may be directly specified or indexed.

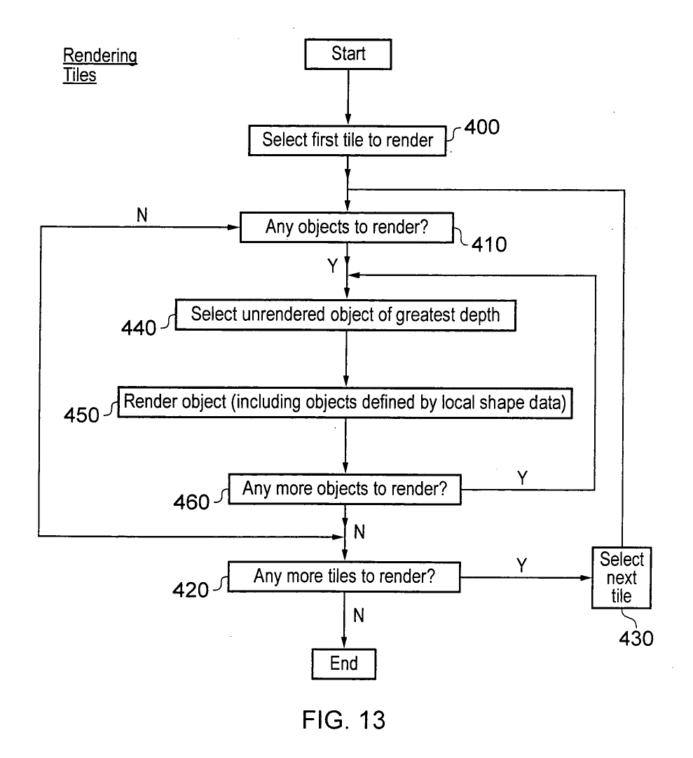

FIG. 13 schematically illustrates the processing that may be performed when rendering tiles. At step 400 the first tile to be rendered is selected. Step 410 determines whether or not there are any objects within the object list for that tile which need to be rendered. If there are no such objects, then processing proceeds to step 420 where a determination is made as to whether or not there are any more tiles to render. If there are more tiles to render, then processing proceeds to step 430 where the next tile is selected and processing is returned to step 410. If there are no more tiles to render at step 420, then processing terminates.

If the determination at step 410 is that there are objects to render within the currently selected tile, then step 440 selects the object of the greatest depth within the object list. This depth may be recorded in a Z-buffer. Step 450 then renders the object currently selected. This rendering includes objects identified by the local shape data generated in accordance with FIG. 17 and the previous description. Step 460 determines whether or not there are any more objects to render. If there are more objects to render, then processing returns to step 440. If there are no more objects to render, then processing proceeds to step 420.

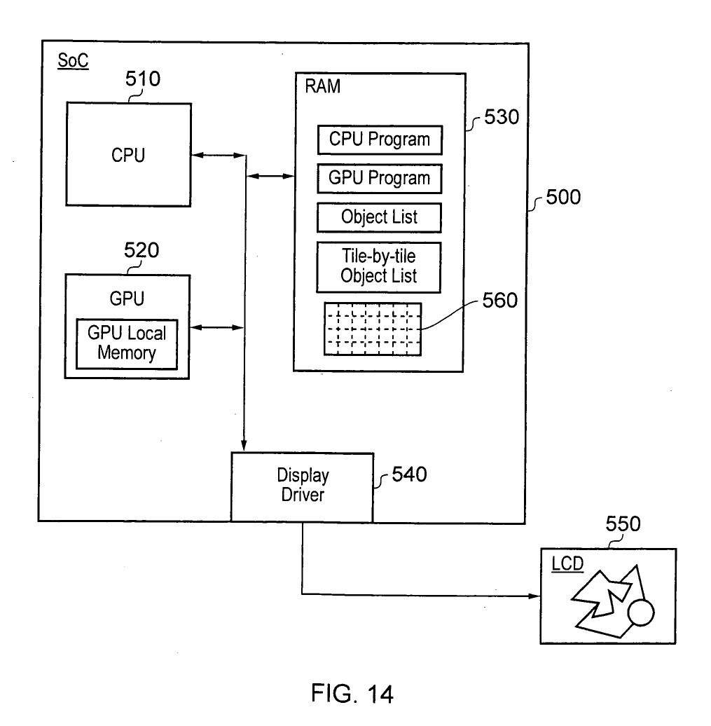

FIG. 14 illustrates a system-on-chip integrated circuit 500 including a central processing unit 510 for executing a general purpose computer program. Also provided within the system-on-chip integrated circuit 500 are a graphics processing unit 520, a memory 530 and a display driver circuit 540. In operation the graphics processing unit 520 generates frames of pixel values to be written to the display driver 540 so as to generate signals for controlling display of a desired image on a display screen 550. The memory 530 includes programs for the central processing unit 510, programs for the graphics processing unit 520, an object list of objects to be drawn, a tile-by-tile object list generated by processing of the more general object list (and including local shape data as discussed above) together with a frame buffer 560 composed of tessellating tiles. A tile is a graphics region and corresponds to an array of pixel values to be drawn on the display 550.

The graphics processing unit 520 contains a local memory into which tiles of pixel values may be assembled using the tile-by-tile object list and other inputs such as textures, lighting data, effects data etc.

It will be appreciated that the above described techniques of drawing filled shapes may be implemented by appropriate programs controlling the central processing unit 510 and the graphics processing unit 520. These programs may be embedded within the system-on-chip integrated circuit 500 or may be loaded using a computer program storage medium, such as a data card. The software programs could also be downloaded into the system-on-chip integrated circuit to be stored within the memory 530.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method of generating a plurality of graphics regions within a frame of graphics data, each graphics region corresponding to an array of pixels for display, said method comprising the steps of:
receiving edge data defining a plurality of edges forming one or more boundaries of a filled shape to be drawn;
generating local shape data from said edge data for at least each graphics region overlapped by said filled shape, said local shape data separately representing for each graphics region at least:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction; and
for each graphics region having local shape data, generating from at least said local shape data pixel values for pixels of said graphics regions that are within said filled shape to be drawn.

2. A method as claimed in claim 1, wherein said filled shape is a filled polygon.

3. A method as claimed in claim 1, wherein said plurality of edges include at least one of:
(i) one or more straight edges; and
(ii) one or more curved edges.

4. A method as claimed in claim 1, wherein said plurality of graphics regions comprises an array of graphics tiles of a common size.

5. A method as claimed in claim 4, wherein said generating of pixel values for pixels of said frame of graphics data is performed separately for each tile of said array of graphics tiles.

6. A method as claimed in claim 1, further comprising the step of detecting as a graphics region fully occluded by said filled shape a graphics region having no edges of said filled shape within said graphics region and an overlap value indicative of said graphics region being within said filled shape.

7. A method as claimed in claim 6, wherein graphics objects to be drawn have an associated depth and further comprising the step of, when a graphics region is detected as fully occluded, all objects identified in an object list to be drawn for said graphics region and having a depth greater than said filled shape are deleted from said object list.

8. A method as claimed in claim 1, wherein said overlap value is indicative of said graphics region being within said filled shape if said overlap value is a non-zero value.

9. A method as claimed in claim 1, wherein said overlap value is indicative of said graphics region being within said filled shape if said overlap value is an odd value.

10. A method as claimed in claim 1, wherein said step of generating said local shape data uses a stencil algorithm forming triangles connecting said one or more of said plurality of edges intersecting said graphics region to one or more reference points.

11. A method as claimed in claim 1, wherein said step of generating said local shape data comprises:
using a triangulation algorithm to form a local filled shape bounded by said one or more edges within said graphics region and edges of said graphics region within said filled shape to be drawn;
dividing said local filled shape in to one or more local three-sided shapes that tessellate to form said local filled shape; and
forming said local shape data to represent said one or more local three-sided shapes.

12. A method as claimed in claim 1, wherein each array of pixels of a graphics region is separately accessed from a memory and said pixel values for pixels of said graphics region that are within said filled shape to be drawn are all written during one access operation.

13. A method as claimed in claim 12, wherein said memory stores an array of pixel values for each of said plurality of graphics regions and said array of pixel values for a graphics region are fetched to a graphics processor to draw that portion of said filled shape within said graphics region during said one access operation.

14. A method as claimed in claim 1, wherein said step of generating local shape data is performed for a bounding block of a plurality of graphics regions, said bounding block fanning a rectangle surrounding said filled shape with said frame of graphics data.

15. A method as claimed in claim 1, wherein said local shape data directly specifies:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction.

16. A method as claimed in claim 1, wherein said local shape data provides an index to data specifying:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction.

17. Apparatus for generating a plurality of graphics regions within a frame of graphics data, each graphics region corresponding to an array of pixels for display, said apparatus comprising:
an edge data receiver coupled to a memory to receive edge data defining a plurality of edges forming one or more boundaries of a filled shape to be drawn;
a local shape generator responsive to said edge data to generate local shape data for at least each graphics region overlapped by said filled shape, said local shape data separately representing for each graphics region at least:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction; and
a render responsive to at least said local shape data to generate for each graphics region having local shape data pixel values for pixels of said graphics regions that are within said filled shape to be drawn.

18. Apparatus for generating a plurality of graphics regions within a frame of graphics data, each graphics region corresponding to an array of pixels for display, said apparatus comprising:
edge data receiving means coupled to a memory for receiving edge data defining a plurality of edges forming one or more boundaries of a filled shape to be drawn;
local shape generating means responsive to said edge data for generating local shape data for at least each graphics region overlapped by said filled shape, said local shape data separately representing for each graphics region at least:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction; and
rendering means responsive to at least said local shape data for generating for each graphics region having local shape data pixel values for pixels of said graphics regions that are within said filled shape to be drawn.

19. A computer program product comprising a computer readable storage medium storing a computer program for controlling a data processing apparatus to perform a method of generating a plurality of graphics regions within a frame of graphics data, each graphics region corresponding to an array of pixels for display, said method comprising the steps of:
receiving edge data defining a plurality of edges forming one or more boundaries of a filled shape to be drawn;
generating local shape data from said edge data for at least each graphics region overlapped by said filled shape, said local shape data separately representing for each graphics region at least:
(i) any edge of said filled shape within said graphics region; and
(ii) an overlap value indicative of a difference between a number of times said one or more boundaries surround said region in a clockwise direction and a number of times said one or more boundaries surround said region in a counter-clockwise direction; and
for each graphics region having local shape data, generating from at least said local shape data pixel values for pixels of said graphics regions that are within said filled shape to be drawn.
